(19) United States
(12) Patent Application Publication
(10) Pub. No.: US 2015/0033549 A1
(43) Pub. Date: Feb. 5, 2015

(54) PROCESSING MACHINE

(71) Applicant: Grob-Werke GmbH & Co. KG, Mindelheim (DE)

(72) Inventor: H.C. Burkhart Grob, Bad Woerishofen (DE)

(21) Appl. No.: 14/450,140

(22) Filed: Aug. 1, 2014

(30) Foreign Application Priority Data
Aug. 1, 2013 (DE) 10 2013 108 314.5

(51) Int. Cl. B23P 19/04

(52) U.S. Cl. CPC B23P 19/04
USPC 29/700

(57) ABSTRACT

The invention concerns a processing machine for machining processing of a workpiece, wherein the processing machine has a stand which supports a motor spindle for the rotative drive of a tool, the motor spindle being movable and positionable along a guide, wherein stand feet are arranged on the side of the stand, with which the stand is supported on a bottom support, for example, a foundation, and the motor spindle is arranged on a motor spindle carriage, and the motor spindle carriage is movable and positionable on the guide, wherein at least the lower end of the motor spindle carriage can be positioned below the stand feet.

### FIELD OF THE INVENTION

The invention relates to a processing machine for the machining processing of a workpiece. The processing machine has a stand which supports a motor spindle for the rotative drive of a tool, the motor spindle being movable and positionable along a guide. An appropriate drive is provided for the moving and positioning of the motor spindle. The motor spindle is provided to rotatively drive a machining tool.

### BACKGROUND OF THE INVENTION

Generic processing machines are sufficiently known.

They are used to carry out a variety of frequently complicated machining processing operations on workpieces, e.g. cylinder heads or transmission housings. The generic processing machines are used as part of processing lines, which are connected using appropriate interlinking or transport means, or as stand-alone universal tool machines. For effective processing of the workpiece, it is advantageous that the workpiece can be positioned and processed highly accurately relative to the tool along a plurality of axes. It is known to divide the effort for the realization of the various linear and rotational axes between the workpiece and the motor spindle. For example, a drilling or milling tool is used for processing which is held and actuated by a motor spindle. The processing tool rotates around a rotational axis. Frequently, a Cartesian design is selected, i.e., the three spatial axes which are perpendicular to one another at a right angle also describe the three linear axes along which the tool and/or workpiece can be positioned. The stand has a guide for the movable and positionable motor spindle; the longitudinal extension of said guide corresponds to the Y-axis; the rotational axis of the (non-pivoted) motor spindle is oriented at a right angle thereto and described as Z-axis. The orientation of the Z-axis or the rotational axis of the motor spindle supporting the tool can run perpendicularly, horizontally or even obliquely in space.

The structure of the known processing machines is such that the mo-tor spindle is supported by a stand which provides a guide in Y-direction for the motor spindle. The stand rests in a suitable manner on the machine bed which, in turn, rests on the foundation of the workshop floor.

These known processing machines are disadvantageous because for an oblique processing from below, the workpiece must be arranged at a higher position and, at the same time, the processing machine must be significantly higher and thus designed bigger and more elaborate to ensure that the motor spindle reaches all regions of the work-piece. The higher perpendicular position of the workpiece also re-quires for the set-up stations to be positioned higher in order to prevent a vertical transport of the workpiece. This can result in corresponding adverse effects for the personnel which assembles, mounts, or disassembles the workpieces on the set-up station.

The known processing machines which are connected using interlinking or transport means and are arranged in processing lines also require significantly higher effort if the workpiece is to be arranged at a higher position for oblique processing from below. Since the transport of the workpieces in such processing lines is automated, either additional automatically operating workpiece lifting devices must be provided or the entire interlinking line must be realized on a higher level, requiring thus additional material.

### SUMMARY OF THE INVENTION

Proceeding from this prior art, the present invention addresses the problem of improving a processing machine of the initially described type, resulting in a more effective utilization of space.

For solving said problem, the invention proposes a processing ma-chine of the initially described type, wherein stand feet are ar-ranged on the sides of the stand with which the stand is supported on a bottom support, e.g. a foundation, and the motor spindle is arranged on a motor spindle carriage and the motor spindle carriage is movable and positionable on the guide, wherein at least the lower end of the motor spindle carriage can be positioned below the stand feet.

In the prior art, the weight of the stand is supported by the bottom support, e.g. a foundation, by means of stand feet which are arranged below the stand. The stand feet, as supporting element, are located on a crossbeam which has an appropriate strength and thus delimits the downward movement. According to the invention, the stand feet, with which the stand is supported, are arranged on the sides of the stand, allowing for the option of using the space of the machine occupied by the crossbeam for a lowering movement of the motor spindle arranged on the motor spindle carriage. According to the invention, it is thus possible to position the motor spindle distinctly lower than is known from the prior art, thus also allowing processing of the workpiece obliquely from below, for example, in case of a motor spindle tilted around a horizontal axis, without having to generally change the height level of the workpiece.

In a preferred embodiment, the stand is movable and positionable along a linear guide and the linear guide is formed by two parallel guide tracks spaced apart from one another, and the stand is supported, by means of the stand feet, by the guide tracks resting on the bottom support.

The bottom support, for example, is the workshop floor, but the foundation can also be the bottom support. The invention comprises the alternative, in which the stand is supported directly by the bottom support, i.e., the foundation, or guide tracks are provided on the bottom support (workshop floor, foundation) and the stand is movably positionable on the guide track. This requires a drive on the processing machine which is controllable and adjustable such that the stand can be positioned in the desired position on the linear guide. Preferably, the linear guide is designed such that it forms the Z-axis; the Z-axis describes the linear axis which is parallel to the rotational axis of the motor spindle if the rotational axis is horizontally oriented.

Since, according to the invention, the stand feet are arranged on the sides of the stand, the guide tracks of the linear guide are also provided on the sides and do not obstruct the space below the stand which is kept free for the travel movement of the motor carriage.

In a further alternative of the invention, the guide is formed by two parallel guide bars spaced apart from one another, wherein the distance of these guide bars is shorter than the distance of the guide tracks of the linear guide. The motor spindle is movable and positionable along a guide on the stand. The design of the guide of the motor spindle with two guide bars results in a very sturdy, constructive structure of the system for mounting the motor spindle carriage.

With the alternatively proposed embodiment, in which the distance of these guide bars is shorter than the distance of the guide tracks (of the linear guide), the downward movement and the lowering of the motor spindle carriage between the guide tracks of the linear guide for processing from below is provided in a constructively simple manner.

It is obvious that the distance of the guide bars and the distance of the guide tracks must be determined in the same or a similar way. For example, the distance is each definable by means of the clear width of the parallel inner edges of the guide track or guide bar which supports either the stand or the motor spindle carriage.

Alternatively, the motor spindle carriage is supported by a relatively wide guide track, in which case the width of this guide track is equivalent to the distance of the two parallel guide bars.

Advantageously, in a further embodiment, the guide bars on the stand extend on both sides of the stand feet. The guide bars of the guide of the spindle carriage are provided above and below the stand feet of the stand and thus allow for at least the lower end of the motor spindle carriage, preferably the rotational axis or the center of gravity of the motor spindle, to be lowered below the height level of the stand feet.

Advantageously, the stand is supported by the bottom sup-port/foundation by means of a linear guide. The linear guide is provided on the side next to the stand since the stand feet are also arranged on the sides of the stand. Advantageously, this results in a design of the linear guide such that the linear guide encompasses the lower region of the stand in a U-like or channel-like manner, wherein, for example, the assembly of the linear guide is substantially designed as one piece, i.e., the two parts which each support the guide track are connected by a middle section, or two separate components which each form the guide track are arranged parallel and thus encompass the stand in a channel-like manner. The second alternative is advantageous because one component each can be provided for forming the left and right guide track and, for example, said guide track element can be adjusted and fastened on the foundation or a supporting plate in a suitable manner without the arrangement of a center beam.

In a further embodiment, at least one first link apron cover is arranged on the movable stand which covers the region of the guide tracks where the stand is not located at a given time. It must be noted that generic processing machines are used for machining processing and the removed cuttings must not interfere with the positional accuracy of the movement of the stand, and due to the arrangement of a link apron cover, the guide tracks are always covered by the link apron cover, wherein the link apron cover does not cover the region where the stand is located at a given time. This provides effective protection of the guide track from contamination by the cuttings.

Alternatively, at least one second link apron cover is arranged on the motor spindle carriage which cases or covers the stand and/or the guide bars in the regions where the motor spindle carriage is not located at a given time.

Each of the proposed link apron covers are arranged such that they encompass the entire guide bar or guide track and connect with the movable element, either the stand or the motor spindle carriage, and are moved by their movement. For such purpose, deflection elements or deflection rollers are provided for the link apron cover at the ends of the guide bar or guide tracks. The use of a link apron cover is advantageous because the regions not covered by the stand or the motor spindle carriage are always flexibly and reliably covered by such link apron cover.

In a further embodiment, the first link apron cover suitably covers the guide track perpendicularly oriented. Of course, it is also possible to arrange the first link apron cover such that it covers the guide track horizontally oriented, even though the thus formed horizontal surface of the link apron cover forms a support region for cuttings which is not advantageous. It is preferable to orient the link apron cover perpendicularly which significantly reduces the risk of cuttings sticking to the link apron cover.

For transferring the load, the guide track is loaded perpendicularly, thus basically accessible from above. Since the link apron cover is suitably arranged such that it is perpendicularly oriented, the upper side of the guide track is protected by a cover which, for example, is suitably oriented perpendicularly, making it easier for cuttings on said cover to slide down and be disposed of.

This ultimately results in an enclosure of the guide track which covers the guide track in a cutting-tight manner except for the side associated with the stand; the side associated with the stand is preferably covered by the link apron cover.

The cover provided on the upper side of the guide track does not rest directly on the guide track but is perpendicularly spaced apart from the guide track such that the stand foot arranged on the side of the stand is able to engage at this point. Thus, a corresponding space is formed above the guide track.

The invention further also comprises the use of the link apron cover for covering the guide bar or the guide track as concretely described for the processing machine.

The use of the link apron cover provides for a very effective protection of the accuracy-sensitive guide bar or guide track. At this point, it must be noted that all features described in conjunction with the link apron cover also apply correspondingly to the use ac-cording to the invention and are each to be considered to be dis-closed and pertaining to the invention.

### BRIEF DESCRIPTION OF THE DRAWINGS

The invention description below refers to the accompanying drawings, of which:

FIG. 1 is a three-dimensional view of the processing machine ac-cording to the invention;

FIG. 2 is a top view (along the Y-axis according to FIG. 1) of the processing machine according to the invention;

FIG. 3 is a view (along the Z-axis) of the processing machine according to the invention.

### DETAILED DESCRIPTION

In the drawings, similar or corresponding elements are each denoted with the same reference sign and, if not practical, will thus not be described again.

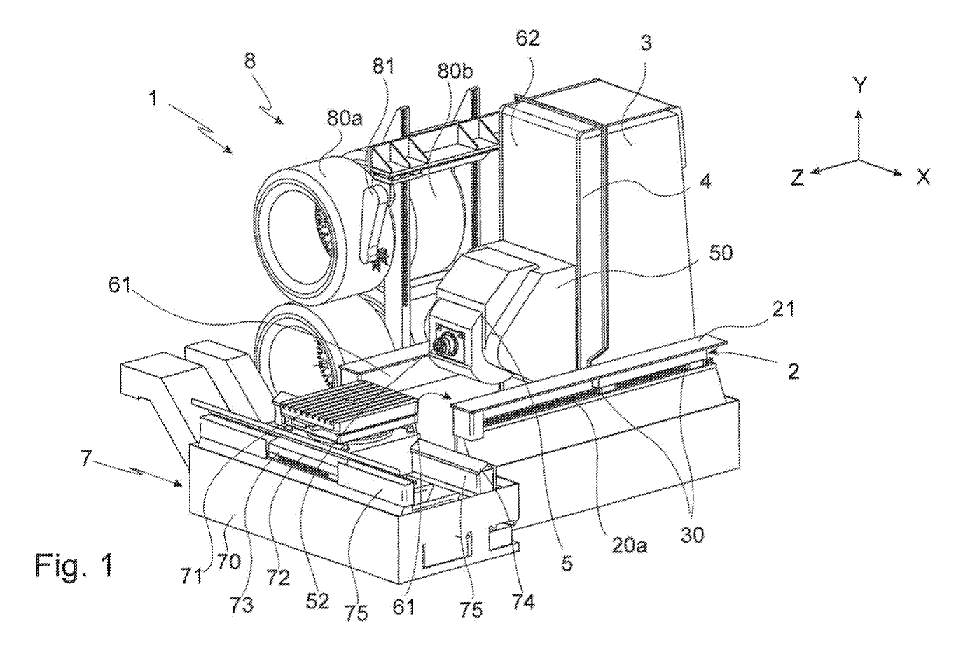

FIG. 1 shows the processing machine 1 according to the invention as an embodiment. It is used to machining-process a not depicted workpiece. The workpiece rests on a workpiece seat 7 and is clamped in said workpiece seat 7 with positional accuracy. The processing machine 1 has a stand 3. The stand 3 is provided with a guide 4, along which the motor spindle carriage 50, which holds the motor spindle 5, is movable and positionable. The motor spindle 5 has a spindle head 52 for receiving the not depicted tool.

The workpiece seat 7 is movable and positionable in the direction of the X-axis; a corresponding drive is provided in the bed 70 of the workpiece seat 7. The workpiece seat 7 thus has a workpiece carriage 71 which is supported by parallel rails 73 by means of carriage feet 72. The upper side of the rails 73 is protected from the cuttings by a stationary cover 74 in a cutting-tight manner; a link apron cover 75 is provided for each rail 73, said link apron cover being fastened to the workpiece carriage 71 and encompasses the rail 73; the link apron cover 75 is closed on the outer side but depicted open for reasons of clarity in order to show the mounting of the carriage feet 72 on the rail 73.

The depicted solution allows for the workpiece on the workpiece seat 7 to be moved and positioned in both directions along the X-axis; the X-axis forms one axis of the Cartesian system.

The second axis of said Cartesian system is the guide 4 of the motor spindle 5 extending in perpendicular direction (Y-axis).

The third axis (Z-axis) is formed by the linear guide 2 which sup-ports the stand 3. Of course, a corresponding drive for the stand 3 is provided on the linear guide 2. The linear guide 2 is formed by the two parallel guide tracks 20a, 20b which support the stand feet 30 of the stand 3.

Similar to the rail 73, which is covered by the link apron cover 75, the guide track 20a, 20b is also protected by a first link apron cover 61 which is arranged according to the same principle and moved by the movement of the stand 3. The structure of both guide tracks 20a, 20b is the same or identical; the covers 21 project beyond each of the upper sides of the guide track 20a, 20b, said covers 21 also project beyond and cover the link apron cover 61.

The guide 4 on the stand 3 is also protected in a cutting-tight manner by a second link apron cover 62, which connects to the motor spindle carriage 50, and which in usage position is substantially oriented perpendicularly, similar to all other link apron covers. Since the front and the back of the link apron covers 61, 62, 75 are connected to each of the moving elements (the workpiece carriage 71, the stand 3, and the motor spindle carriage 50) in the direction of movement, one part of the link apron cover 61, 62, 75 is pushed by the moving element and the other part is pulled by the moving element. The link apron cover 61, 62, 75 remains at a constant length and thus covers the space below in a cutting-tight manner.

In addition, rotational axes, for example in the workpiece seat 7 and/or in the motor spindle holder or motor spindle 5, can be pro-vided which allows for very adaptable processing. Suitably, these rotational axes are also arranged parallel to the linear axes X, Y, Z of the realized Cartesian system. At the same time, the invention is not limited to this geometric aspect. The axes (linear and rotational axes) can also have a different spatial orientation to each other.

In addition to the stand 3, a tool storage unit 8 is provided which is formed with two times two tool discs 80a, b. The tool storage unit 8 further comprises a tool changing unit 81 for inserting tools 83 from the tool discs 80a, b into the spindle head 52 as well as to change or replace said tools 83 and to put the replaced tool 83 back into the tool discs 80 of the tool storage unit 8. The tool changing unit 81 is can be moved perpendicularly (in the direction of the Y-axis) and has a hinged lever which allows for pivoting to the appropriate position of the of the tool discs 80a, b and with which the spindle head 52 can be reached for the changing and replacing process.

Due to the arrangement of a tool storage unit 8 on the processing machine according to the invention, the area of application of such a processing machine is significantly broadened since the great flexibility with the position of the motor spindle 5 relative to the workpiece also allows for corresponding processing with all kinds of tools which are held available in the tool storage unit 8.

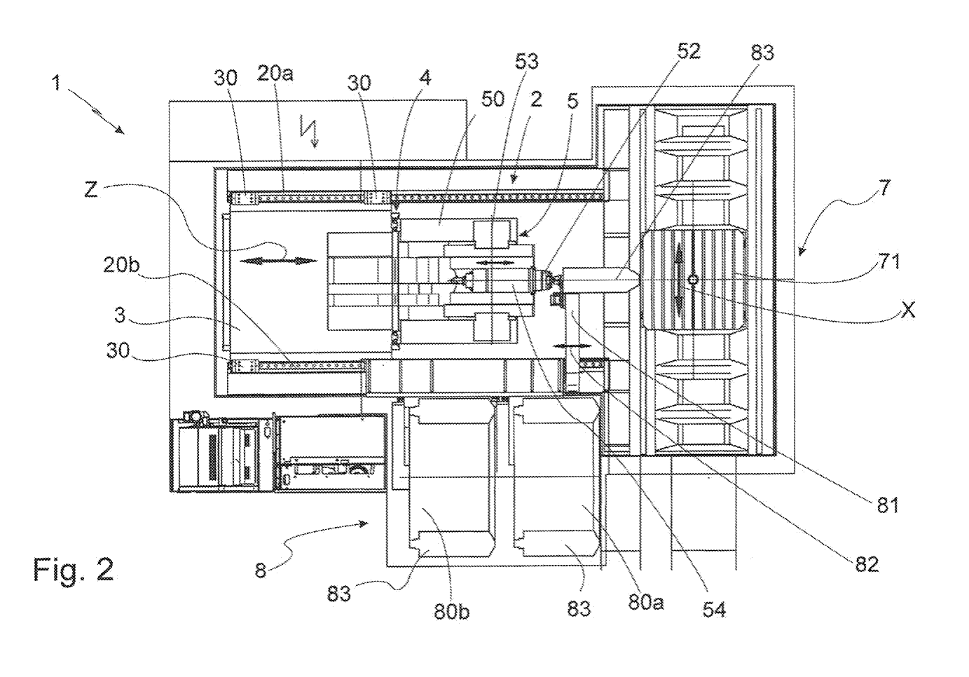

FIG. 2 shows a top view (in the direction of the Y-axis). The movability of the workpiece carriage 71 is denoted by the double arrow X (parallel to the X-axis of the machine-internal Cartesian system).

The linear guide 2 is formed by the two guide tracks 20a, 20b; the movability of the stand 3 in Z-direction is denoted by the double arrow Z.

In the depicted embodiment, the motor spindle 5 (as assembly) is formed by the motor spindle carriage 50 which receives the around a pivot axis 53 rotatable tool spindle 54 (precisely positionable by a drive). In the depicted embodiment, the tool spindle 54 rotates the spindle head 52. It is possible to also provide a tail spindle, resulting in a separate propulsion for the tool for the pivoted tool spindle 54.

The tool changing unit 81 can be moved not only linearly or pivot-ably in the direction of the Z-axis but, as denoted by the double arrow 82, but also parallel to the Z-axis so as to reach both tool discs 80a, 80b, which, in this embodiment, are arranged in a row as seen looking in the direction of the Z-axis, for inserting and re-moving of the tools 83.

In the position shown in FIG. 2, a tool 83 is inserted into the spindle head 52 by the tool changer 81.

It is apparent that pivot or linear drives are provided for the different movements of the tool changer 81.

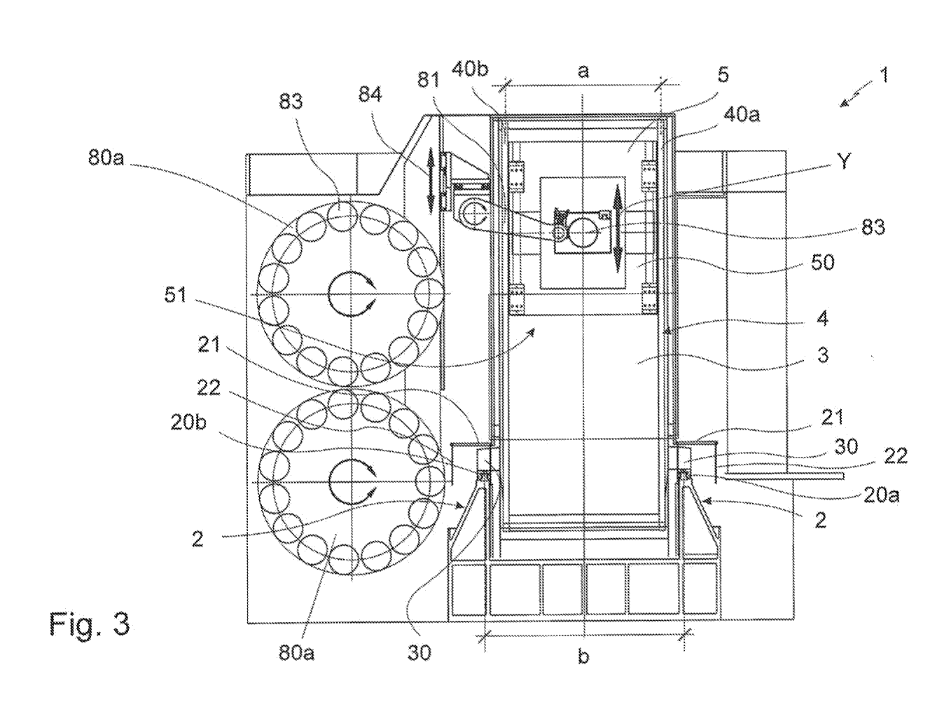

FIG. 3 shows a view in the direction of the X-axis. It clearly shows how the stand 3 is supported on the guide tracks 20a, 20b of the linear guide 2 by means of the stand feet 30 arranged on the side of the stand 3. An enclosure 22 is provided for the guide tracks 20a, 20b which also has an upper cover 21 and side elements in order to protect the guide tracks 20a, 20b as much as possible in a cutting-tight manner. This is completed with the link apron cover 61 (see FIG. 1).

In the position shown in FIG. 3, the motor spindle carriage 50 is arranged relatively high up in order to allow for a change of the tool 83. The movability of the motor spindle carriage 50 in perpendicular direction is denoted with the double arrow Y (in Y-direction).

The tool changing unit 81 is also movable and positionable in one direction parallel to the Y-axis (see double arrow 84) in order to remove from or deposit in the tool discs 80a, b the appropriate tools 83.

It can be clearly seen that the lower end 51 of the motor spindle carriage 50 can be lowered below the stand feet 30 since the guide tracks 20a, 20b are located on the side next to the stand 3. This is achieved because distance a of the guide tracks 40a, 40b forming the guide 4 is shorter than distance b of the guide tracks 20a, 20b of the linear guide 2. This results in a channel- or U-shaped design of the linear guide 2 which encompasses or surrounds the lower region of the stand 3.

The tool discs 80 are rotatable around a horizontal axis of rotation.

The present filing of claims with the patent application and subsequent filing of claims are without prejudice to seeking further protection.

If upon closer examination, in particular also of the relevant prior art, it is shown that one feature or another is advantageous for the objective of the invention but not crucially important, it is understood that a wording is sought which no longer has such a feature, in particular in the main claim. Such a subcombination is also encompassed by the disclosure of the present patent application.

It is further noted that the forms and variants of the invention described in the various embodiments and shown in the figures may be arbitrarily combined with one another. In this regard, individual or multiple features may be arbitrarily replaced with one another. These feature combinations are likewise disclosed herein.

The back-references stated in the dependent claims refer to the further embodiment of the subject matter of the main claim through the features of the respective subclaim. However, this is not to be construed as forgoing the seeking of independent, objective protection for the features of the back-referenced subclaims.

Features which have been disclosed only in the description, or also individual features of claims which include a plurality of features, may be incorporated at any time into the independent claim or claims as having importance essential to the invention for delimitation from the prior art, even if such features have been mentioned in conjunction with other features, or achieve particularly advantageous results in conjunction with other features.

What is claimed is:

1. Processing machine for machining processing of a workpiece comprising”
a stand which supports a motor spindle for the rotative drive of a tool, the motor spindle being movable and positionable along a guide,
wherein stand feet are arranged on the side of the stand, with which the stand is supported on a bottom support, and
wherein the motor spindle is arranged on a motor spindle carriage, and
wherein the motor spindle carriage is movable and positionable on the guide, and
wherein at least the lower end of the motor spindle carriage is positionable below the stand feet.

2. Processing machine according to claim 1 wherein the stand is movable and positionable along a linear guide and the linear guide is formed by two parallel guide tracks spaced apart from one another, and the stand is supported, by the stand feet, by the guide tracks resting on the bottom support.

3. Processing machine according to claim 2, wherein the guide is formed by two parallel guide bars spaced apart from one another, wherein a distance a of the guide bars is shorter than a distance b of the guide tracks.

4. Processing machine according to claim 2, wherein the guide bars on the stand extend on both sides of the stand feet.

5. Processing machine according to claim 2, wherein the linear guide encompasses the lower region of the stand in a U-like or channel-like manner.

6. Processing machine according to claim 2, wherein at least one first link apron cover is arranged on a movable stand which covers the region of the guide tracks where the stand is not located at a given time.

7. Processing machine according claim 6, wherein at least one second link apron cover is arranged on the motor spindle carriage which cases or covers the stand and/or the guide bars where the motor spindle carriage is not located at a given time.

8. Processing machine according to claim 6, wherein the first link apron cover covers the guide track perpendicularly oriented.

9. Processing machine according to claim 2, at least one of the guide tracks has a cover on an upper side thereof.

10. Processing machine according claim 9, wherein at least one of the guide tracks is, except for the side associated with the stand, cased by an enclosure in a cutting-tight manner.

11. Processing machine according to claim 1 wherein the bottom support comprises a foundation.
